(19) United States
(12) Patent Application Publication
(10) Pub. No.: US 2012/0292251 A1
(43) Pub. Date: Nov. 22, 2012

(54) METHOD AND APPARATUS FOR MONITORING BIOLOGICAL ACTIVITY AND CONTROLLING AERATION IN AN ACTIVATED SLUDGE PLANT

(75) Inventor: David G. Palmer, Lincoln, NE (US)

(73) Assignee: Process Kinetics, LLC, Lincoln, NE (US)

(21) Appl. No.: 13/521,806

(22) PCT Filed: Jan. 24, 2011
(86) PCT No.: PCT/US2011/022187

§ 371 Date: Jul. 12, 2012

Related U.S. Application Data
(60) Provisional application No. 61/297,914, filed on Jan. 25, 2010.

(51) Int. Cl. C02F 3/12

(52) U.S. Cl. 210/614; 210/96.1

(57) ABSTRACT

A method and apparatus for operating an activated sludge plant having a plurality of tandem aeration zones, each receiving mixed liquor from an upstream zone or an upstream source and discharging a mixed liquor to a downstream zone or a downstream process includes a control which determines a parameter at a downstream one of the zones. The parameter is representative of a concentration of ammonia in the mixed liquor in the downstream one of the zones and may be used to control at least one upstream zone. A value of airflow to one of the zones may be determined and used to determine a demand for dissolved oxygen in the mixed liquor in that zone as a function of airflow to that zone. An elevated level of demand may be used to indicate a dump of commercial waste having a high BOD demand. A depressed level of demand may be used to indicate the presence of chemicals that inhibit bacterial respiration.

### BACKGROUND OF THE INVENTION

The present invention is directed to an activated sludge plant and method for monitoring biological activity and controlling aeration in such a plant and, in particular, to such a plant being operated for ammonia removal.

In the secondary process of a conventional activated sludge treatment plant, effluent from primary clarifiers is mixed with return activated sludge (RAS) to form mixed liquor. The mixed liquor consists of a suspension of flocs containing microbial species, which include heterotrophic and autotrophic bacteria. Both need oxygen in order to remove carbon and ammonia respectively from the surrounding solution. In the aeration section, high-volume low-pressure blowers are used to provide air to the aeration zones. Originally, blowers were turned on and a fixed volume of air was provided in an uncontrolled fashion. With the advent of dissolved oxygen (DO) sensors, instrument engineers recognized that the aeration system could be controlled. The blowers were operated to achieve a targeted header pressure. Each aeration zone had a DO sensor and an air control valve. PID logic was used to control the air valve in order to target a fixed DO set-point.

DO has become the primary parameter monitored by plant operators. Most plants have several aeration zones usually each having a different DO set-point. DO is not an indicator of the rate at which ammonia is being converted into nitrate (nitrification rate). Operators become concerned when the actual DO value in a zone moves away from the set-point and remains away for an extended period of time—a daily occurrence in most plants. DO in mixed liquor is a complex parameter that is not well understood by operators and engineers. Hence, operating practices are often based upon misunderstandings and myths that result in energy being wasted and the risk of treatment being compromised. DO set-point control was designed by instrument engineers to control blowers.

### SUMMARY OF THE INVENTION

In order to control the rate at which carbon compounds and ammonia are being removed by microbes, there is a need for a parameter that relates the rate of biological activity to airflow in each aeration zone and in the aeration system as a whole.

Both the flow of water and the concentration of compounds generated by humans vary significantly over a 24-hour period. Municipal wastewater treatment plants experience peak water flows and concentrations around noon with the low points being around sunrise. This diurnal effect is due to people waking up all about the same time each morning and using the toilet and the shower. Traditionally, plants that are run with fixed DO set-points will experience that, around sunrise, nitrification will be completed very early in the process while, around noon, the target ammonia discharge value may not be achieved before the mixed liquor exits the aeration system. DO values are set to ensure that the targeted discharge levels are usually achieved. For zones where the rate of ammonia removal cycles over a 24 hour period between being only marginally affected by ammonia concentration to being strongly affected, traditional DO set-point control using PID logic cannot operate in a stable fashion. Up to 70% of the aeration zones in a conventional plant can be so affected.

Hence, while the accuracy and response of DO sensors has improved dramatically, stable DO control has remained elusive. In early zones where the ammonia concentration typically remains above 2.5, a conventional PID loop can be tuned so that DO remains close to the set-point throughout the day. In this situation, the rate of removal of ammonia is only marginally dependent upon ammonia concentration and mainly a function of airflow and DO. In aeration zones closer to the outlet ammonia concentrations will typically fall below 2.5 mg/L and the rate of ammonia removal will thus be increasingly governed by the ammonia concentration as shown in FIG. 3. For a fixed DO set-point, as the ammonia level falls, so too will the airflow required to maintain the DO set-point.

In the range 0-3.0 mg/l, increasing DO increases the rate of nitrification. However, DO has an affect on the efficiency with which oxygen is transferred from the blower air into the mixed liquor. The lower the DO the more oxygen will be transferred from the same airflow.

The present invention is directed to a method and apparatus for monitoring biological activity in an activated sludge plant controlled by conventional techniques to provide the operator with useful information on the biological activity in individual aeration zones. The present invention is further directed to a method and apparatus for controlling the aeration of the activated sludge plant in a manner that provides a stable process that is capable of reducing energy used in aeration. This is accomplished by changing the nitrification rate to fully utilize the time available for treatment. The technique endeavors to utilize minimum DO values in each aeration zone while achieving desired nitrification. This results in an efficient exchange of oxygen into the mixed liquor which minimizes air volume, thereby realizing energy savings.

A method and apparatus for operating an activated sludge plant having a plurality of tandem aeration zones, each receiving mixed liquor from an upstream zone or an upstream source and discharging a mixed liquor to a downstream zone or a downstream process, according to an aspect of the invention, includes providing a control which determines a parameter at a downstream one of the zones. The parameter is representative of a concentration of ammonia in the mixed liquor in the downstream one of the zones.

At least one upstream zone that is upstream of the downstream one of the zones may be controlled as a function of a value of the parameter. The downstream one of the zones may be the most downstream zone. The at least one upstream zone may be controlled in order to cause the concentration of ammonia in the downstream one of the zones to approach a particular level, such as less than approximately 2.5 mg/L. The at least one upstream zone may be controlled by controlling airflow to that zone. Airflow to the at least one upstream zone may be measured to the at least one upstream zone controlled as a function of airflow to the at least one upstream zone.

The parameter may be representative of a demand for dissolved oxygen in the mixed liquor of the downstream one of said zones. The parameter may be proportional to airflow to the downstream one of the zones. The parameter may be proportional to the difference between a second parameter and dissolved oxygen in the mixed liquor. The second parameter may be a value of saturated concentration of oxygen in the mixed liquor.

The at least one upstream zone may be controlled by establishing a set-point control for that zone and the set-point of that zone adjusted as a function of the value of the parameter at the downstream one of said zones. A value of the parameter at the at least one upstream zone may be calculated and utilized at the at least one upstream zone in the set-point control. A set-point value of the parameter may be established at the at least one upstream zone and adjusted as a function of the value of the parameter at the downstream one of the zones. Set-point values of the parameter may be established at a plurality of upstream zones and the sum of the set-point values at the plurality of upstream zones may be adjusted as a function of changes in the value of the parameter at the downstream one of the zones. The set-point control may adjust the dissolved oxygen set-point or the airflow set-point to at least one of the upstream zones.

A method and apparatus for operating an activated sludge plant having a plurality of tandem aeration zones, each receiving mixed liquor from an upstream. zone or an upstream source and discharging mixed liquor to a downstream zone or a downstream process, according to another aspect of the invention, includes providing a control and determining a value of airflow to one of the zones with the control. A value of a parameter is determined for that zone as a function of airflow to that zone. The parameter is representative of a demand for dissolved oxygen in the mixed liquor in that zone.

That zone may be controlled as a function of a value of the parameter. The parameter may be proportional to the difference between a second parameter and the level of dissolved oxygen in the mixed liquor in that zone. The second parameter may include a value of saturated concentration of oxygen in the mixed liquor in that zone. A feedback control may be established in that zone. The feedback loop adjusts airflow to that zone to cause the level of the parameter to approach a set-point level. The feedback loop may adjust a dissolved oxygen set-point level in the mixed liquor of that zone in order to cause the level of the parameter to approach the set-point level.

The set-point level of the parameter may be established as a function of a condition in a downstream zone that is downstream of that zone. The condition in the downstream zone may be the concentration of ammonia in the mixed liquor in the downstream zone. A value of the parameter may be determined in a plurality of the zones and the airflow to the plurality of zones adjusted to cause the level of the parameter in the plurality of zones to approach set-point levels for those zones. A sum of the set-point levels for the plurality of zones may be adjusted as a function of changes of the condition in the downstream zone.

A method and apparatus for operating an activated sludge plant having a plurality of tandem aeration zones, each receiving mixed liquor from an upstream zone or an upstream source and discharging mixed liquor to a downstream zone or a downstream process, according to another aspect of the invention, includes providing a control and determining a value of airflow to one of the zones with the control. A value of a parameter is determined for that zone as a function of airflow to that zone. The parameter is representative of a demand for dissolved oxygen in the mixed liquor in that zone. An elevated level of the parameter may be used to indicate a dump of commercial waste having a high BOD demand. A depressed level of the parameter may be used to indicate the presence of chemicals that inhibit bacterial respiration.

These and other objects, advantages and features of this invention will become apparent upon review of the following specification in conjunction with the drawings.

### BRIEF DESCRIPTION OF THE DRAWINGS

FIG. 1 is a block diagram of an activated sludge wastewater treatment plant, according to the invention;

FIG. 2 is a schematic diagram of a control for an aeration zone;

FIG. 3 is a diagram illustrating the relationship between metabolic rate and concentration of ammonia;

FIG. 4 is a control algorithm diagram illustrating overall control of the aeration zones of the plant in FIG. 1;

FIG. 5 is a flow diagram of an iterative control process for controlling an aeration zone;

FIG. 6 is the same view as FIG. 5 of an alternative embodiment thereof;

FIG. 7 is a schematic diagram of a conventional activated sludge wastewater treatment plant;

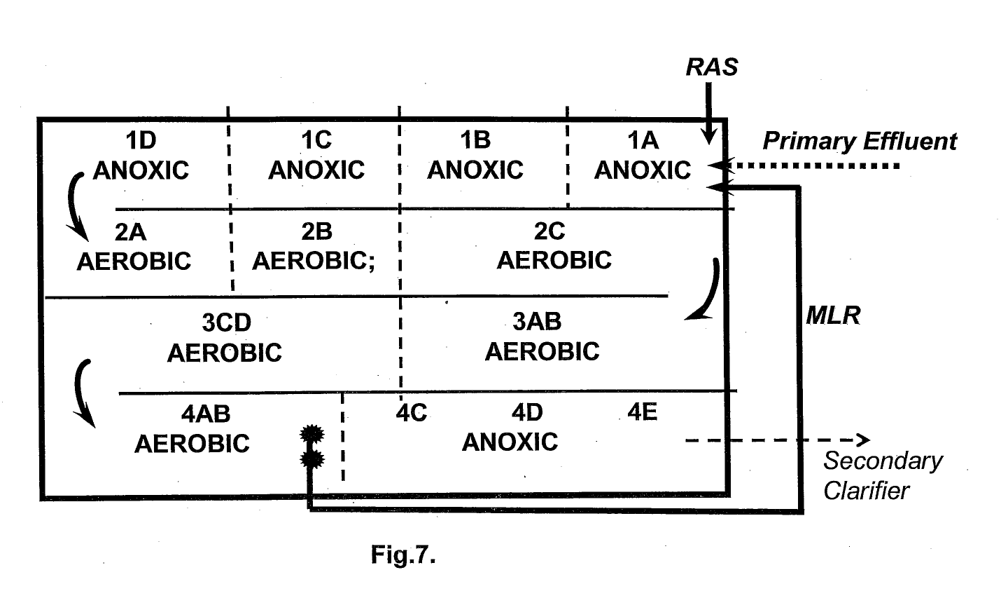

FIG. 8 is a diagram illustrating hourly variation of dissolved oxygen in the mixed liquor stream in the aeration zones of the plant in FIG. 7;

FIG. 9 is a diagram illustrating hourly variation of biological activity index (BAI) in the mixed liquor stream in the aeration zones of the plant in FIG. 7;

FIG. 10 is a diagram illustrating, for multiple days, hourly variation of total biological activity index (MAI) in the mixed liquor stream in the aeration zones of the plant in FIG. 7;

FIG. 11 is a diagram illustrating variations of the daily average total biological activity index in the mixed liquor stream in the aeration zones in the plant in FIG. 7;

FIG. 12 is a diagram illustrating hourly variation of BAI during a dump of commercial waste to a plant similar to that in. FIG. 7;

FIG. 13 is a diagram illustrating hourly variation of TBAI during a dump of commercial waste to a plant similar to that in FIG. 7; and

FIG. 14 is a diagram illustrating hourly variations of TBAI/Q in the mixed liquor stream in the aeration zones of the plant in FIG. 7.

### DESCRIPTION OF THE PREFERRED EMBODIMENT

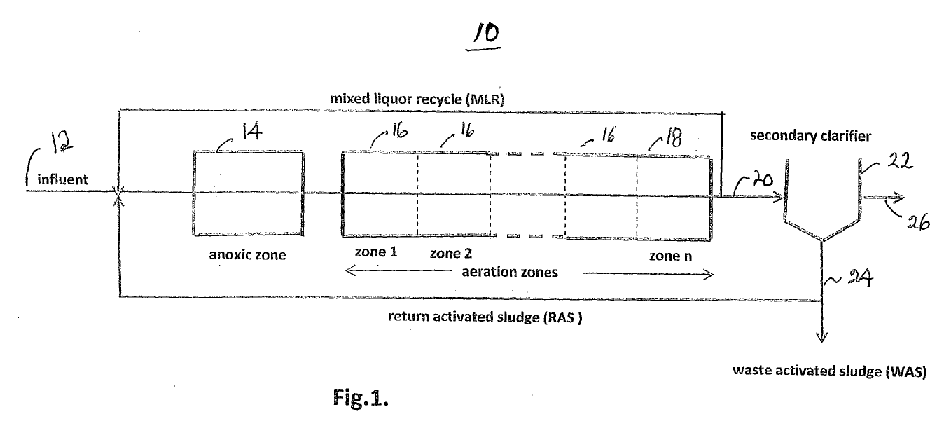

Referring now to the drawings and the illustrative embodiments depicted therein, an activated sludge wastewater treatment plant 10 is shown in FIG. 1. Waste is fed to an influent line 12 from an upstream supply, such as a primary clarifier effluent, and is supplied to a conventional anoxic zone 14. The effluent of zone 14 is supplied to a tandem series of aeration zones 16, which are designated zone 1, zone 2, . . . zone n in the direction of flow of the mixed liquor (primary effluent plus return activated sludge plus mixed liquor recycle). Each of the zones receives mixed liquor from an upstream zone and discharges mixed liquor to a downstream zone. In the aeration sections of an activated sludge process, air is bubbled through the mixed liquor. This provides the dissolved oxygen that certain species require in order to use the carbon compounds and ammonia present in the mixed liquor. The output 20 of final aeration zone 18 is recycled to influent line 12 in the form of mixed liquor recycled and to a secondary clarifier 22. At least a portion of waste-activated sludge 24 from clarifier 22 is recycled to influent 12 as return-activated sludge providing flocs containing microbiological species to mix with the influent. The treated wastewater effluent is fed out of line 26.

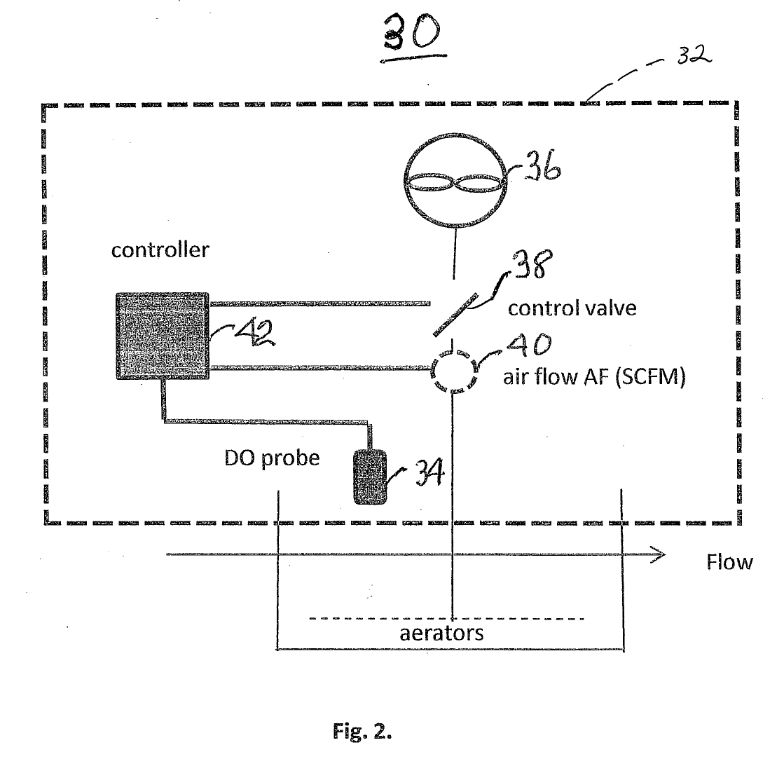

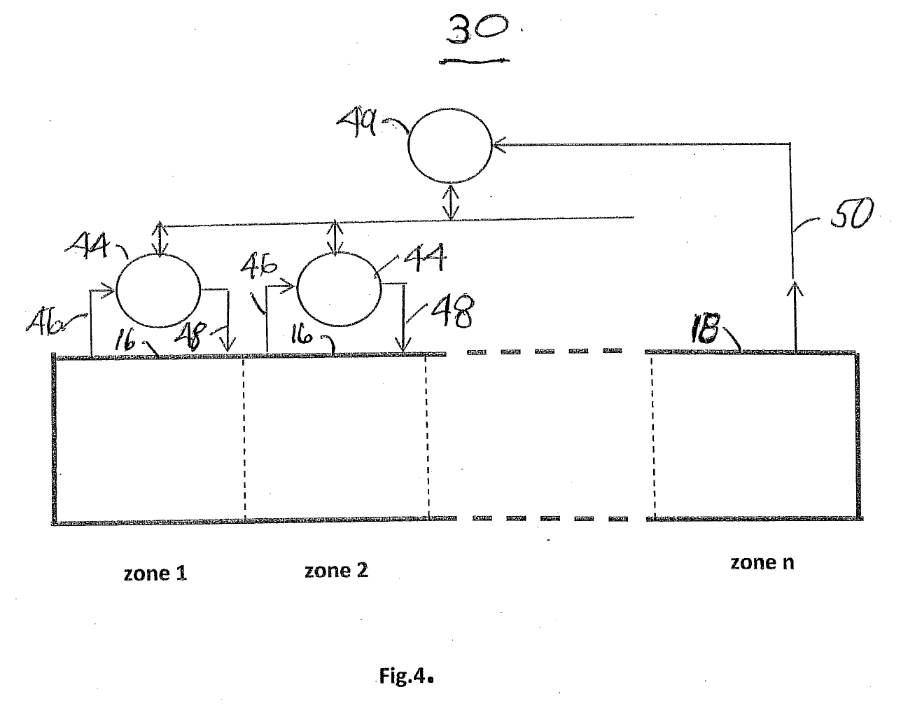

Wastewater treatment plant 10 includes a control generally shown at 30 (FIGS. 2 and 4). Control 30 includes a zone control 32 for controlling an aeration zone 16 having an air source 36. Control 32 includes a conventional DO probe 34 for sensing dissolved oxygen in the mixed liquor in that zone. Control 32 includes a control device 38 for controlling airflow from air source 36. While control device 38 may be a valve to modulate airflow to that zone from an air source 36 in the form of a blower that is common to more than one zone, it could also be a speed control for a separate variable speed fan, or the like. Zone control 32 additionally includes an airflow sensor 40 for determining a value of airflow to that zone. Devices 34, 38 and 40 connect with a controller 42, which may be dedicated to that zone or shared across the zones 16.

Zone control 32 operates as follows. Zone control 32 controls air control device 38 in that zone so as to target an airflow set-point—AFₛₚ. This ensures a stable flow of air to the zone. Zone control 32 has a controller 42 that monitors the DO value via a probe 34 and calculates the value of a parameter BAI (biological activity index). Parameter BAI is representative of a demand for dissolved oxygen in the mixed liquor in that zone.

BAI, the Biological Activity Index for a zone, is defined as:

BAI=AF*(β*Cₛₐₜ−DO) (1)

where Cₛₐₜ is the saturation concentration of oxygen in water and DO is the dissolved oxygen concentration measured in the mixed liquor. Cₛₐₜ is a function of temperature. β is a constant that is between 0.5 and 1.0, but in the illustrated embodiment is approximately 0.95.

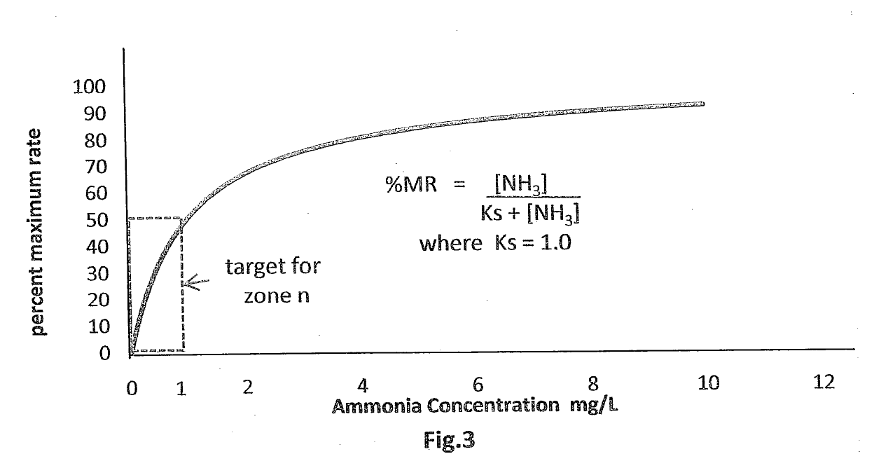

BAI is proportional to the rate at which oxygen is being transferred into the mixed liquor in a zone. The BAI reflects the demand for dissolved oxygen which depends upon the needs of heterotrophic bacteria that have access to soluble carbon and autotrophic bacteria with access to ammonia. Under normal conditions, all soluble carbon is removed in the anoxic zone. Hence, oxygen being supplied to the aeration zones is principally being used by heterotrophic bacteria for nitrification. In early aeration zones, the rate at which ammonia is removed will be only slightly dependent upon the concentration of ammonia. This is due to the relationship between metabolic rate and substrate concentration shown in FIG. 3. The rate will depend upon the dissolved oxygen concentration (DO), the mixed liquor suspended solids (MLSS), the relative number of nitrifying bacteria in the mixed liquor, the geometry of the flocs, and the water temperature. Of these, the DO can change rapidly, whereas the other parameters change only slowly. When the DO is steady, the rate at which oxygen is being removed from the zone will equal the rate at which oxygen is being transferred into the zone. Hence, the BAI will generally be proportional to the rate at which oxygen is being consumed by the bacteria.

Thus, it can be seen that a value of the parameter BAI can be used as a target in a feedback control algorithm 44 carried out by zone control 32 in the aeration zone (FIG. 4). If the zone is controlled using traditional DOₛₚ control, the feedback loop 44 adjusts the DO set-point for the zone. This will cause the air flow to change. Alternatively, the zone could be controlled using an air flow set-point—AFₛₚ. The feedback loop 44 adjusts the AFₛₚ which will cause the DO to change DO probes respond more slowly than air flow controls. Also, it takes time for the DO profile inside the floc to become stabilized. Hence, time must be allowed for the new DO and/or AF value to become stable before the value of the BAI corresponding to such changes is established.

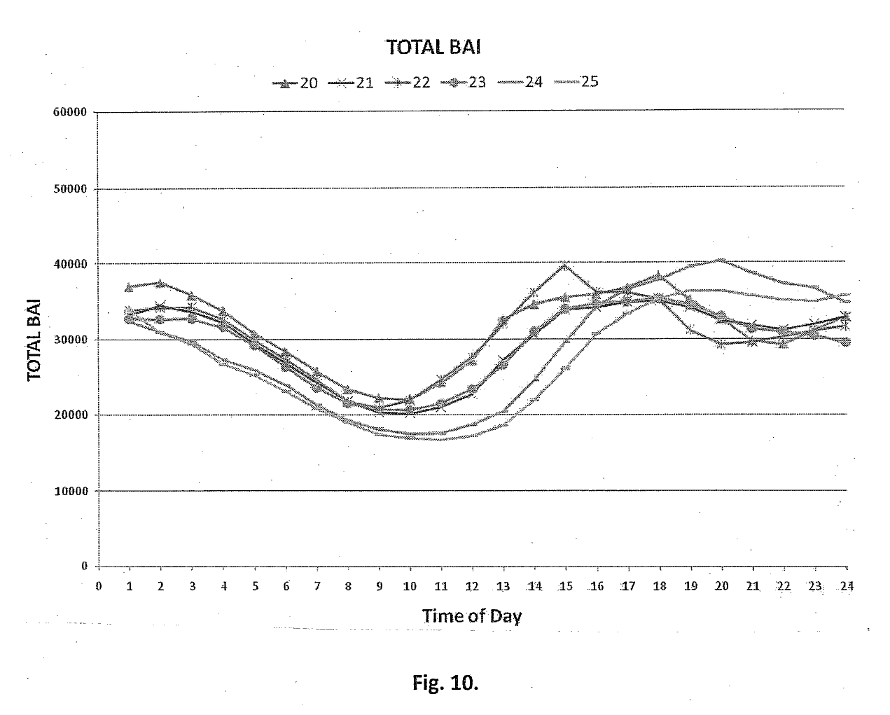

The BAI levels in zones 1 through n appear to be additive. FIG. 10 shows plots of TBAI the sum of BAI for zones 1 through n, for several days

The rate of nitrification depends upon the ammonia concentration according to the expression:

$$\% maximum rate = \frac{[ NH 4 ]}{( 1.0 + [ NH 4 ] )} \qquad ( 2 )$$

where 1.0 is the value used in the Activated Sludge Model for Kₛ for ammonia as shown in FIG. 3. When the ammonia concentration in a zone is around 1 mg/L the parameter BAI becomes a strong linear indicator of ammonia concentration. Zone n can be controlled using traditional DO set-point control, or with an appropriate fixed airflow, and BAI monitored. With traditional DO set-point control, a value of 1.0 mg/L or less can be chosen in order to minimize carryover of DO with mixed liquor recycling line 24 back to the anoxic zone 14. Changes in the concentration of ammonia in zone n will be reflected in changes in BAI, Correlation can be established by taking samples and recording the BAI. Laboratory analysis can be used to establish ammonia concentrations. Hence, an ammonia target level in the discharge can be translated into a BAIT target (BAIₜ).

A change in BAI in the downstream zone n, can be used to change the target value for the TBAI for earlier zones 1 through n-1. This can be illustrated by reference to FIG. 4 in which each upstream zone, upstream of zone n, has a feedback control loop 44 which receives input 46 from the condition of the associated zone and provides an output 48 to control that zone. All controllers 44 send the condition of their zone to controller 49. Downstream zone n produces an output value 50 representative of the BAI of that zone, which is compared by controller 49 to BAIₜ for zone n. A new TBAI target is calculated by controller 49 as well as new BAI targets for control loops 44, for one or more of the upstream zones. In so doing, controller 49 will endeavor to maximize oxygen transfer by keeping the DO values in zones 1 through n-1 at minimum values. Whenever changes are made to either the AF set-point or the DO set-point in a zone, time must be allowed for the system to stabilize. Until DO becomes stabilized, BAI cannot be taken as an indicator of the rate at which bacteria are using DO. This can take anywhere from 5-30 minutes, for example, but will mostly be achieved in less than 15 minutes.

Each zone feedback loop 44 of the upstream zones may utilize various set-point parameters in order to change the BAI for that zone. One such set-point parameter may be the airflow for that zone. An iterative process involving incrementally changing AF set-points then waiting for the DO to stabilize will be described in more detail below. Alternatively, upstream zones may utilize DO as a set-point in an iterative process involving incrementally changing DO set-points then waiting for the airflows and DO to stabilize, as will be described in more detail below. The goal is to control the BAI in zones 1 through n-1 so that the ammonia levels in zone n stay close to a target value, e.g., 0.5 mg/L throughout the day. Thus, if, in a chosen period of time (for example 15 minutes), the BAI in zone n increases by ΔBAI, the difference between the actual BAI and BAIₜ, the value of total biological activity index (TBAI) is increased by an amount proportional to ΔBAI. If, in a chosen period of time, the BAI in zone n decreases by ΔBAI, TBAI is decreased by an amount proportional to ΔBAI.

While the ammonia concentration in the downstream zone n may be determined from the BAI level in that zone, it may, alternatively, be determined by other techniques, such as using an online ammonia analyzer.

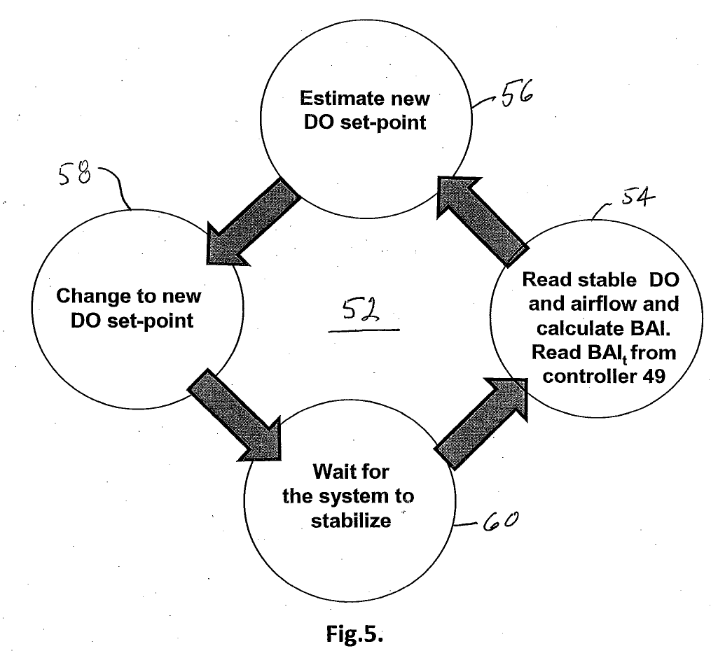

A goal is to operate with set-points in upstream zones 1 through n-1 so that the rate of nitrification remains steady as evidenced by relatively stable DO and BAI values in these zones. Changing the value for the BAI in earlier zones may be used by feedback control loop 44 in an iterative process involving incrementally changing DO set-points then waiting for the airflows to stabilize, as illustrated in FIG. 5. In particular, a feedback control algorithm 52 may be carried out in which the BAI is determined in that zone from airflow and DO readings. Controller 49 has determined ΔBAI in downstream zone n and calculated a new BAIₜ for the zone which is read at 54. This is used at 56 to estimate a new DO set-point for the zone. The new DO set-point is adopted at 58, and the airflow to the zone is automatically adjusted. Parameters in the zone are allowed to stabilize at 60 and a new BAI value is determined for the zone at 54. If the new BAI is not sufficiently close to BAIₜ, the loop can be repeated. With experience, a relationship between DO set-point and the BAI may be established and used to speed up the process.

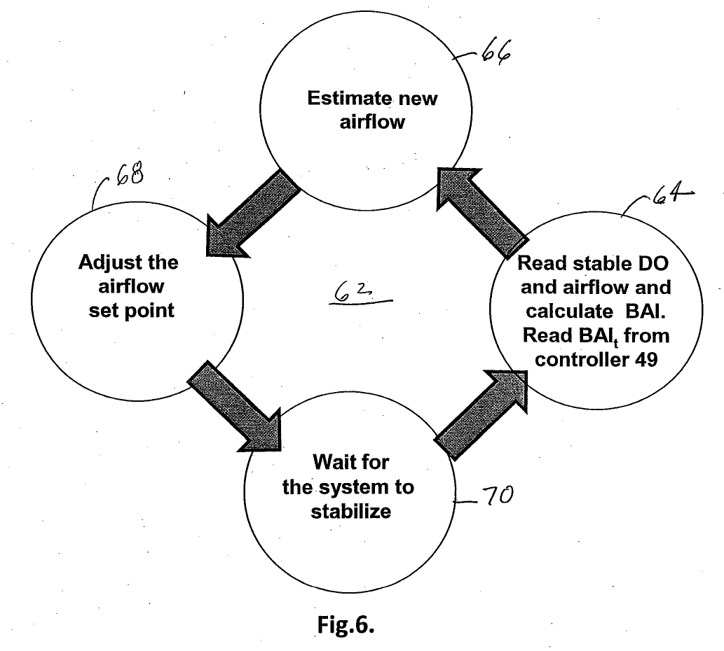

Alternatively, upstream zones 1 through n-1 can be operated with BAI targets calculated by controller 49 for each zone, as illustrated in FIG. 6. A feedback control algorithm 62 includes determining the BAI from stable DO levels and airflow at 64 and reading the value for BAIₜ from controller 49. A new air flow set-point is estimated at 66. Change is made to the airflow set-point at 68. Once the DO level has stabilized at 70, the value for BAI is calculated and compared with the target at 64. An iterative process is used to make further changes to the airflow in order to approach the BAI set-point

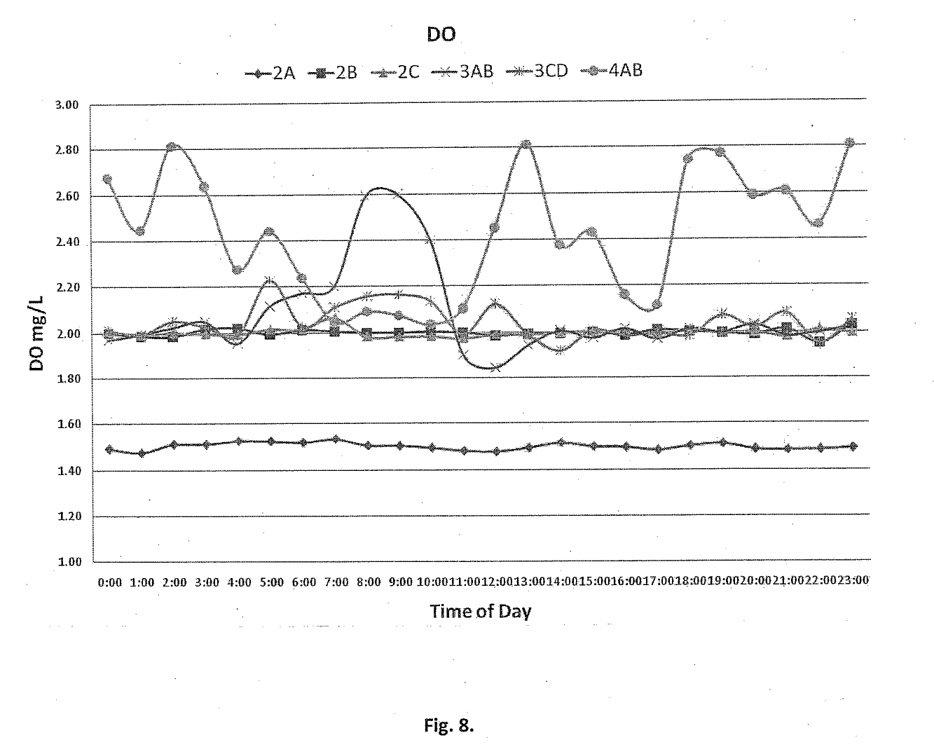

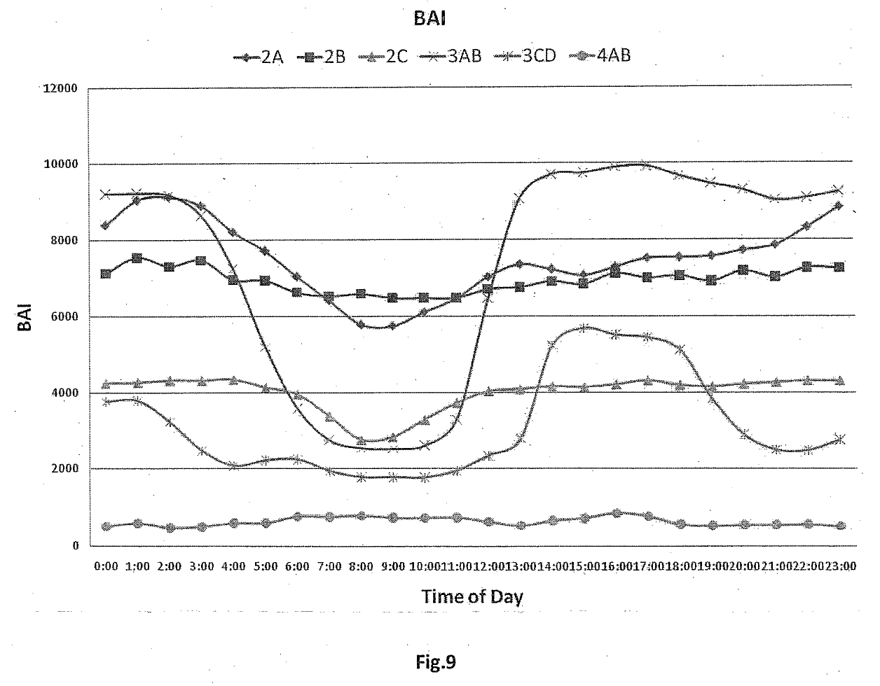

As previously set forth, the goal is to operate upstream zones 1 through n-1 so that nitrification is spread evenly across zones 1 through n-1 as evidenced by relatively stable BAI values in these zones. This is an improvement over conventionally controlled activated sludge plants in which expected levels of DO and BAI vary to a great extent according to the time of day, especially for downstream zones. This is seen in FIGS. 8 and 9. For example, referring to FIG. 8, it can be seen that the DO level in aeration zone 3AB has a major increase starting at about 6:00 a.m. then goes below the set-point of 2.0 close to noon and finally stabilizes around 3:00 p.m. The DO level in zone 4A is only close to its set-point between 8:00 a.m. and noon. Calculating the parameter BAI for the conventional plant utilizing formula (1), it can be seen from FIG. 9 that the value of the BAI for zone 2C shows a drop between 7:00 a.m. and noon. The BAI for zone 3AB starts falling at around 4:00 a.m. from around 9000 to 2300. It starts rising rapidly around noon and two hours later is over 9000. The BAI for zone 3CD starts falling around 2:00 a.m. from 3800 to around 2000. It rises markedly around 2:00 p.m. when the BAI in 3AB flattens out then falls off. This suggests that around 9:00 a.m. nitrification has been completed upstream of zone 3AB. Around 4:00 p.m. nitrification is still occurring in zone 3CD. It should be noted that zone 3CD in the conventional system could correspond to zone n-1, according to the embodiment of the invention, and zone 4AB corresponds to final zone n (18).

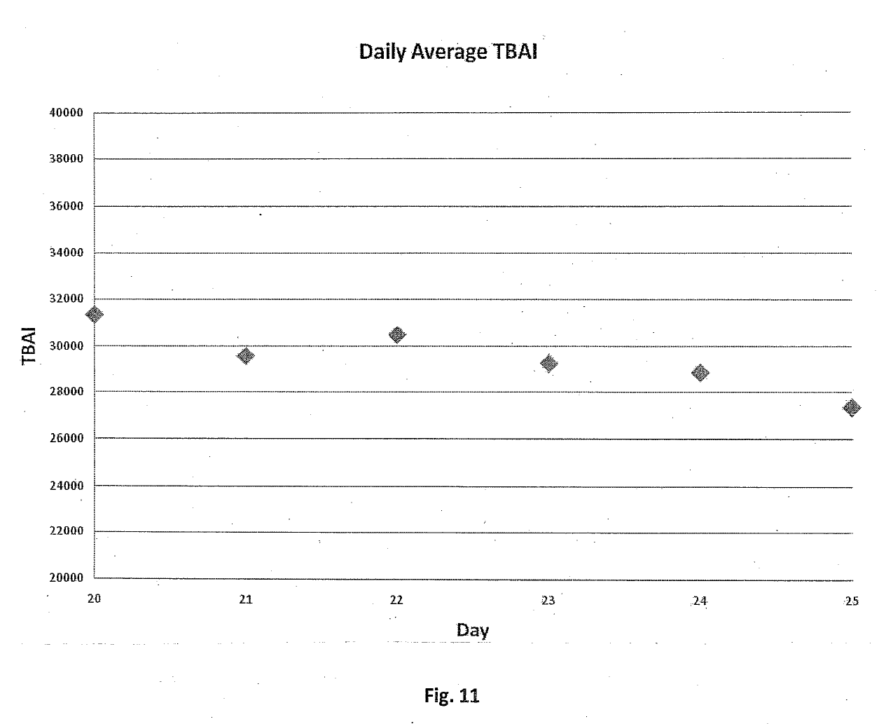

By applying the techniques disclosed herein, the goal would be to adjust the BAI targets for zones 2A, 2B ,2C, 3AB and 3CD so that nitrification is completed in Zone 4AB throughout the day. FIG. 10 shows a plot of TBAI over 24 hours for 6 consecutive days. This illustrates diurnal behavior similar to typical ammonia load variations entering the anoxic zone. FIG. 11 shows the average TBAI for the same 5 days.

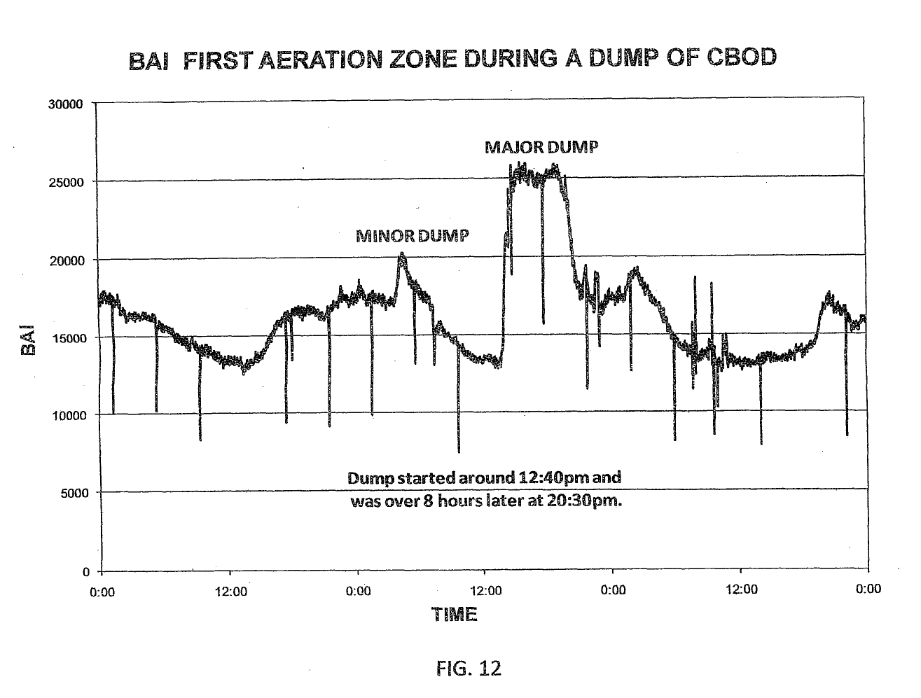

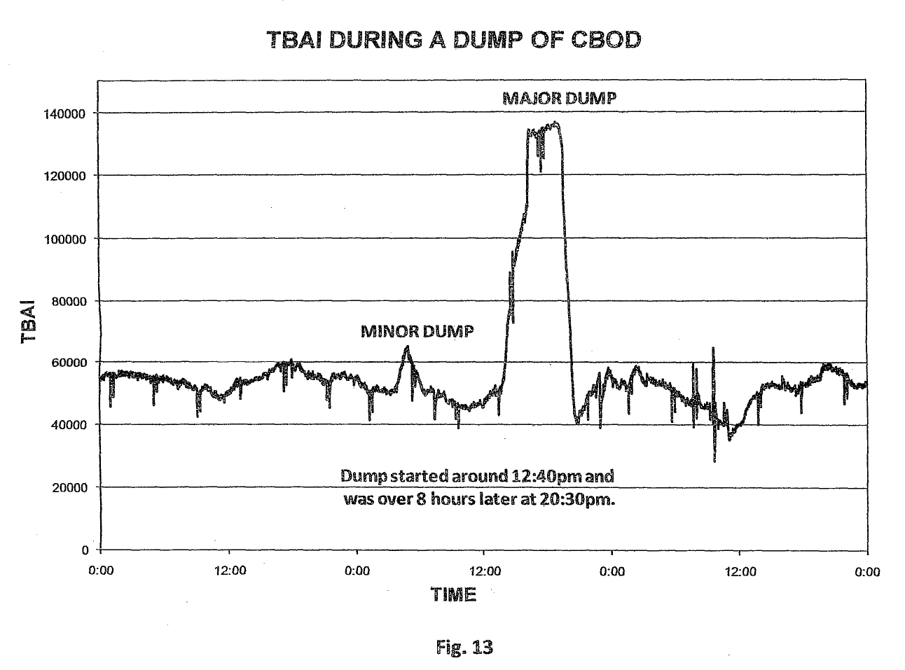

The techniques carried out by control 30 may also he used to alert plant operators to a dump of commercial waste to wastewater treatment plant 10. These occur in many commercial processing plants, such as food-processing plants, or the like, due to discharge of product or wash water from food-processing industries. Normally, readily available carbonaceous biochemical oxygen demand (CBOD) does not get past anoxic zone 14 where it is consumed by denitrifying bacteria. When a dump of commercial waste occurs, CBOD may break through anoxic zone 14 into the aeration zones 16 causing a high demand for DO by the heterotrophs that exist in much greater numbers than nitrifiers. This may cause DO levels to suddenly plummet. The air supply must be ramped up immediately to its maximum allowable value to maximize the rate oxygen is being transferred into the mixed liquor so that the dump can be processed in the shortest possible time. A sudden rise in the BAI, such as in the first aeration zone, can be used to alarm that a dump has occurred and airflows raised in all zones. By monitoring the TBAI during the dump, its magnitude can be established, as well as a clear indication as to when the dump is over and the plant can return to normal operation. Reference is made to FIGS. 12 and 13 where it can be seen how BAI in the first aeration zone can be used to alarm that a dump has occurred and how TBAI can be used to establish the magnitude of the dump. Also, a sudden rise in the BAI may be used to trigger automatic samplers so that the compound can be established and the perpetrator identified.

Also, the parameter BAI in one of the early upstream zones can be used to detect the presence of compounds that inhibit bacterial respiration. When this occurs on a large scale, the bacteria in the treatment plant can die, thus putting the plant out of action for months. The presence of compounds in the influent to the plant that inhibit bacterial respiration will cause a drop in BAI in the upstream zones below its normal pattern. This can be used to alarm so that action can be taken to protect the bacteria population from being destroyed. For example, the primary influent could be temporarily diverted around the aeration zones, or the like.

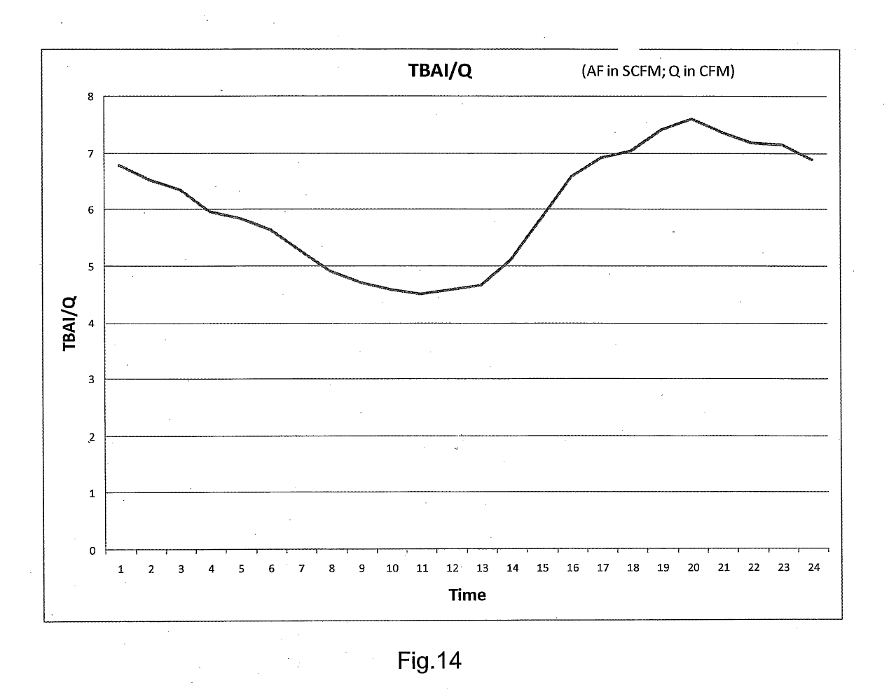

BAI/Q, where Q is the flow rate of mixed liquor through the zones, will be proportional to the oxygen utilized per unit of mixed liquor while passing through the zone. Under normal conditions this will be used by nitrifying bacteria to convert ammonia into nitrate and for endogenous respiration. Because Q is the same for each aeration zone, TBAI/Q will be proportional to the oxygen used per unit volume of mixed liquor while passing through the aeration train. The hourly variation of TBAI/Q is shown in FIG. 14. When divided by the suspended solids in the mixed liquor it will track the specific rate of nitrification. Such trends can be used to increase or decrease sludge wasting. Data may be averaged over 24 hours or analyzed for daily peak or minimum values.

Changes and modifications in the specifically described embodiments can be carried out without departing from the principles of the invention which is intended to be limited only by the scope of the appended claims, as interpreted according to the principles of patent law including the doctrine of equivalents.

1. A method of operating an activated sludge plant, said plant having a plurality of tandem aeration zones, each of said zones receiving activated mixed liquor from an upstream zone or an upstream process, each of said zones discharging activated waste stream to a downstream zone or a downstream process, said method comprising:
determining a parameter at a downstream one of the zones, the parameter being representative of rate of nitrification in the mixed liquor in said downstream one of the zones.

2. The method as claimed in claim 1 including controlling at least one upstream zone that is upstream of said downstream one of said zones as a function of a value of the parameter.

3. The method as claimed in claim 2 wherein said downstream one of the zones comprises the most downstream one of said zones.

4. The method as claimed in claim 2 including controlling the at least one upstream zone in order to cause the concentration of ammonia in said downstream one of the zones to approach a particular level.

5. The method as claimed in claim 4 wherein said particular level is less than approximately 2.5 mg/L.

6. The method as claimed in claim 2 including controlling the at least one upstream zone by controlling airflow to said at least one upstream zone.

7. The method as claimed in claim 2 including measuring airflow to said at least one upstream zone and controlling said at least one upstream zone as a function of airflow to said at least one upstream zone.

8. The method as claimed in claim 1 wherein said parameter is representative of rate at which oxygen is being transferred to the mixed liquor of said downstream one of said zones.

9. The method as claimed in claim 8 wherein said parameter is proportional to airflow to said downstream one of the zones.

10. The method as claimed in claim 9 wherein said parameter is proportional to the difference between a second parameter and dissolved oxygen in the mixed liquor.

11. The method as claimed in claim 10 wherein said second parameter comprises a value of saturated concentration of oxygen in the mixed liquor.

12. The method as claimed in claim 2 including controlling the at least one upstream zone by establishing a set-point control for that zone and adjusting the set-point of that zone as a function of the value of the parameter at said downstream one of said zones.

13. The method as claimed in claim 12 including calculating a value of the parameter at said at least one upstream zone and utilizing the value of the parameter at said at least one upstream zone in said set-point control.

14. The method as claimed in claim 13 including establishing a set-point value of the parameter at said at least one upstream zone and adjusting the set-point value of the parameter at said at least one upstream zone as a function of the value of the parameter at said downstream one of said zones.

15. The method as claimed in claim 14 including establishing set-point values of the parameter at a plurality of said upstream zones and adjusting the sum of the set-point values at the plurality of said upstream zones as a function of changes in the value of the parameter at said downstream one of said zones.

16. The method as claimed in claim 12 wherein said set-point control adjusts at least one chosen from the dissolved oxygen concentration or the airflow to said at least one of said upstream zones.

17. A method of operating an activated sludge plant, said plant having a plurality of tandem aeration zones, each of said zones receiving activated mixed liquor from an upstream zone or an upstream process, each of said zones discharging activated mixed liquor to a downstream zone or a downstream process, said method comprising:
determining a value of airflow to one of said zones; and
determining a value of a parameter in said one of said zones as a function of airflow to that zone, said parameter being representative of rate at which oxygen is being transferred to the mixed liquor in said one of said zones.

18. The method as claimed in claim 17 including controlling said one of said zones as a function of a value of the parameter.

19. The method as claimed in claim 17 wherein said parameter is proportional to the difference between a second parameter and the level of dissolved oxygen in the mixed liquor in said one of said zones.

20. The method as claimed in claim 19 wherein said second parameter comprises a value of saturated concentration of oxygen in the mixed liquor in said one of said zones.

21. The method as claimed in claim 18 including establishing a feedback control in said one of the zones, said feedback loop adjusting airflow to that said one of said zones to cause the level of said parameter to approach a set-point level.

22. The method as claimed in claim 21 wherein said feedback loop adjusts a dissolved oxygen set-point level in the mixed liquor of said one of said zones in order to cause the level of said parameter to approach the set-point level.

23. The method as claimed in claim 22 including establishing the set-point level of said parameter as a function of a condition in a downstream zone that is downstream of said one of said zones.

24. The method as claimed in claim 23 wherein said condition in the downstream zone comprises rate of nitrification in the mixed liquor in said downstream zone.

25. The method as claimed in claim 18 including determining a value of the parameter in a plurality of said zones and adjusting the airflow to said plurality of said zones to cause the level of said parameter in said plurality of said zones to approach set-point levels for said plurality of said zones.

26. The method as claimed in claim 25 including adjusting a sum of the set-point levels for said plurality of said zones as a function of changes of said condition in said downstream zone.

27. A method of operating an activated sludge plant, said plant having a plurality of tandem aeration zones, each of said zones receiving activated mixed liquor from an upstream zone or an upstream process, each of said zones discharging activated mixed liquor to a downstream zone or a downstream process, said method comprising:
determining a value of airflow to one of said zones;
determining a value of a parameter in said one of said zones as a function of airflow to that zone, said parameter being representative of rate at which oxygen is being transferred to the mixed liquor in said one of said zones; and
utilizing an elevated level of said parameter to indicate a dump of commercial waste to the plant.

28. An activated sludge plant, comprising:
a plurality of tandem aeration zones, each of said zones receiving activated mixed liquor from an upstream zone or an upstream process, each of said zones discharging activated mixed liquor to a downstream zone or a downstream process, said method comprising:
a control, said control monitoring mixed liquor in at least some of said zones and determining a parameter at a downstream one of the zones, the parameter being representative of rate of nitrification in the mixed liquor in said downstream one of the zones.

29. The activated sludge plant as claimed in claim 28 wherein said control controls at least one upstream zone that is upstream of said downstream one of said zones as a function of a value of the parameter.

30. An activated sludge plant, comprising:
a plurality of tandem aeration zones, each of said zones receiving activated mixed liquor from an upstream zone or an upstream process, each of said zones discharging activated mixed liquor to a downstream zone or a downstream process, said method comprising:
a control, said control monitoring mixed liquor in at least some of said zones;
said control determining a value of airflow to one of said zones; and
said control determining a value of a parameter in said one of said zones as a function of airflow to that zone, said parameter being representative of rate at which oxygen is being transferred to the mixed liquor in said one of said zones.

31. The activated sludge plant as claimed in claim 30 wherein said control controls said one of said zones as a function of a value of the parameter.

32. The activation sludge plant as claimed in claim 30 wherein said control utilizing an elevated level of said parameter to indicate a dump of commercial waste to the plant.

33. The activation sludge plant as claimed in claim 30 wherein said control determines a value of said parameter in one of said zones as a function of mixed liquor flow rate.
